(19) United States
(12) Patent Application Publication
(10) Pub. No.: US 2016/0094411 A1
(43) Pub. Date: Mar. 31, 2016

(54) SYSTEM AND METHOD FOR OPTIMIZING PERFORMANCE OF AGENTS IN AN ENTERPRISE

(71) Applicant: Avaya Inc., Santa Clara, CA (US)

(72) Inventors: Fergal Brennan, Galway (IE); Peter Flannery, Galway (IE); David Saunders, Galway (IE)

(21) Appl. No.: 14/496,505

(22) Filed: Sep. 25, 2014

(51) Int. Cl. H04L 12/24; H04L 12/26

(52) U.S. Cl. CPC H04L 41/5009; H04L 43/0876; H04L 41/147; H04L 41/046

(57) ABSTRACT

An optimization computer system for optimizing performance of at least one agent in an enterprise is disclosed. The system includes a monitoring module configured to monitor one or more performance parameters of the at least one agent, wherein the at least one agent is managing one or more work requests. The optimization system further includes a computing module configured to compute at least one score for each of the one or more performance parameters and compare the at least one score with one or more predefined thresholds associated with the one or more performance parameters. The optimization system further includes a work management module configured to manage the one or more work requests assigned to the at least one agent based on comparison of the at least one score with the one or more predefined thresholds.

### BACKGROUND

1. Field

Embodiments of the present invention generally relate to a system and method to manage service levels of an enterprise and particularly to a system and method for optimizing performance of agents in an enterprise.

2. Description of Related Art

Contact centers are employed by many enterprises to service inbound and outbound contacts from customers. A primary objective of contact center management is to ultimately maximize contact center performance and profitability. An ongoing challenge in contact center administration is monitoring and optimizing contact center efficiency usage of its available resources. The contact center efficiency is generally measured by metrics such as Service Level Agreement (SLA), Customer Satisfaction (CSAT), and match rate. Contact center resources may include, agents, communication assets (e.g., number of voice trunks, number and bandwidth of video trunks, etc.), computing resources (e.g., a speed, a queue length, a storage space, etc.), and so forth.

Service level is one measurement of the contact center efficiency. Service level is typically determined by dividing the number of contacts accepted within a specified period by the number accepted plus number that were not accepted, but completed in some other way (e.g., abandoned, given busy, canceled, flowed out). Service level definitions may vary from one enterprise to another.

Match rate is another indicator used in measuring the contact center efficiency. Match rate is usually determined by dividing the number of contacts accepted by a primary skill level agent within a period of time by the number of contacts accepted by any agent in a queue over the same period. An agent with a primary skill level is one who typically may manage contacts of a certain nature more effectively and/or efficiently as compared to an agent of lesser skill level.

There are other contact center agents who may not be as proficient as the primary skill level agent, and those agents are identified either as skill level agents or backup skill level agents. As can be appreciated, contacts received by a primary skill level agent are typically manage more quickly and accurately or effectively (e.g., higher revenue attained) than a contact received by a secondary or even backup skill level agent. Thus, it is an objective of most contact centers to optimize match rate along with the service level.

In addition to service level and match rate performance measures, contact centers use other Key Performance Indicators (“KPIs”), such as revenue, estimated, actual, or predicted wait time, average speed of answer, throughput, agent utilization, agent performance, agent responsiveness and the like, to calculate performance relative to their Service Level Agreements (“SLAs”). Operational efficiency is achieved when the KPIs are managed near, but not above, SLA threshold levels.

Throughput is a measure of the number of calls/contact requests or work requests that may be processed in a given amount of time. Agent utilization is a measure of how efficiently the agents' time is being used. Customer service level is a measure of the time customers spend waiting for their work to be manage. Company contact center customers wish to provide service to as many requests as possible in a given amount of time, using the least number of agents to do so, and minimizing the wait time for their customers that may increase the Service Level Agreement (SLA) of the contact center. Further, the contact center may also have to maintain the Customer Satisfaction (CSAT) metrics in order to maintain the KPIs of the contact center. For this purpose, agents may have to maintain the quality of services provided to the customers through multimedia (e.g., voice calls, video calls, emails, etc.).

In today's scenario, agents of the contact center have the capability to simultaneously manage multiple work requests (multiplicity) of different media types (e.g., voice, emails, web chats, etc.). For example, an agent may manage a live video call while simultaneously having the functionality to respond to multiple non-voice work requests, such as web chats, emails, text messages, etc. Some of the agents may excel in managing multiple tasks while others may struggle. Also, multiplicity may have increased work throughput of each agent of the contact center and may have reduced the customer's waiting time for an available agent. However, the multiplicity of the agents has greatly increased human error rates while attempting to manage multiple work requests at same time. For example, if an agent who is managing a voice call and simultaneously communicating with another customer through a web chat, then the customer communicating through the web chat may become frustrated as response time of the agent is reduced for that customer.

Next, during the multitasking of the agents there can be an increased potential for the agents to make errors that further impacts the quality of the customer service. The errors can be, for example, spelling/grammatical mistakes, context mistakes, process mistakes, providing wrong information to customers, etc. Further, this may increase pressure on the agent to ensure customers the agent is trying his/her best to provide better services. Also, the increased pressure can lead the agent to exhibit signs of negative behaviors such as postponing a back end system to complete a customer interaction, skipping validation steps to complete customer interaction, prematurely disconnecting a customer's work request, and so forth. These factors may further reduce the performance of the agent in the contact center.

Conventionally, a supervisor or a manager of the contact center may manually have to detect the above discussed issues by recording a communication session of the agent with the customer, or walking the agent floor to detect the performance of the agents. Further, these techniques rely on historical data, post interaction analysis of reports, or customer feedback surveys to determine the cause for drop in the performance of the agents. However, these techniques do not take actions based on the real time pressure of the work requests on the agents of the contact center.

There is thus a need for a system and method for optimizing performance of agents in a contact center in real time environment.

### SUMMARY

Embodiments in accordance with the present invention provide an optimization system for optimizing performance of at least one agent in an enterprise. The optimization system includes a monitoring module for monitoring one or more performance parameters of the at least one agent, wherein the at least one agent is managing one or more work requests. The optimization system further includes a computing module for computing at least one score for each of the one or more performance parameters and compare at least one score with one or more predefined thresholds associated with the one or more performance parameters. The optimization system further includes a work management module configured to manage one or more work requests assigned to at least one agent based on comparison of at least one score with one or more predefined thresholds.

Embodiments in accordance with the present invention further provide a computer-implemented method for optimizing performance of at least one agent in an enterprise. The method includes monitoring one or more performance parameters of the at least one agent, wherein the at least one agent is managing one or more work requests, computing at least one score for each of the one or more performance parameters, comparing the at least one score with one or more predefined thresholds associated with the one or more performance parameters, and managing the one or more work requests assigned to the at least one agent based on comparison of the at least one score with the one or more predefined thresholds.

Embodiments in accordance with the present invention further provide a computer-implemented method for optimizing performance of at least one agent in an enterprise. The method includes monitoring one or more performance parameters of the at least one agent, wherein the at least one agent is managing one or more work requests, computing at least one score for each of the one or more performance parameters, comparing the at least one score with one or more predefined thresholds associated with the one or more performance parameters, and allocating at least one resource to manage the one or more work requests.

Embodiments of the present invention may provide a number of advantages depending on its particular configuration. First, the present application provides a system and a method for optimizing performance of an agent in a contact center. The agent may have the capability to manage multiple work requests at a same time. The present application monitors performance parameters of an agent managing multiple work requests and based on their performance further actions are taken.

For example, an additional resource is allocated to manage the work requests assigned to the agent. The present application determines load and/or pressure on the agent due to assigned work requests. The present application may also alleviate growing pressure on the agents managing multiple work requests. Further, the present application provides aid to the agents of the contact center based on real time monitoring of their performance and work load assigned to them.

These and other advantages will be apparent from the present application of the embodiments described herein.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram depicting a contact center, according to an embodiment of the present invention;

FIG. 1B illustrates a high level hardware abstraction of a block diagram of a server, according to an embodiment of the present invention;

FIG. 2 illustrates a functional block diagram of the server that may be used in the contact center, according to an embodiment of the present invention;

FIG. 3 illustrates an exemplary process flow in which various embodiments may be implemented, according to an embodiment of the present invention;

FIG. 4 depicts a flowchart of a method for optimizing performance of agents in an enterprise, according to an embodiment of the present invention; and

FIGS. 5A and 5B depict a flowchart of a method for optimizing performance of agents in an enterprise, according to an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., the Avaya Aura® system. Although well suited for use with, e.g., a system having an Automatic Call Distribution (ACD) or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a private Branch Exchange (PBX), an ACD, an enterprise switch, or other type of communications system switch or server, as well as other types of processor-based communication control devices such as media servers, computers, adjuncts, etc.

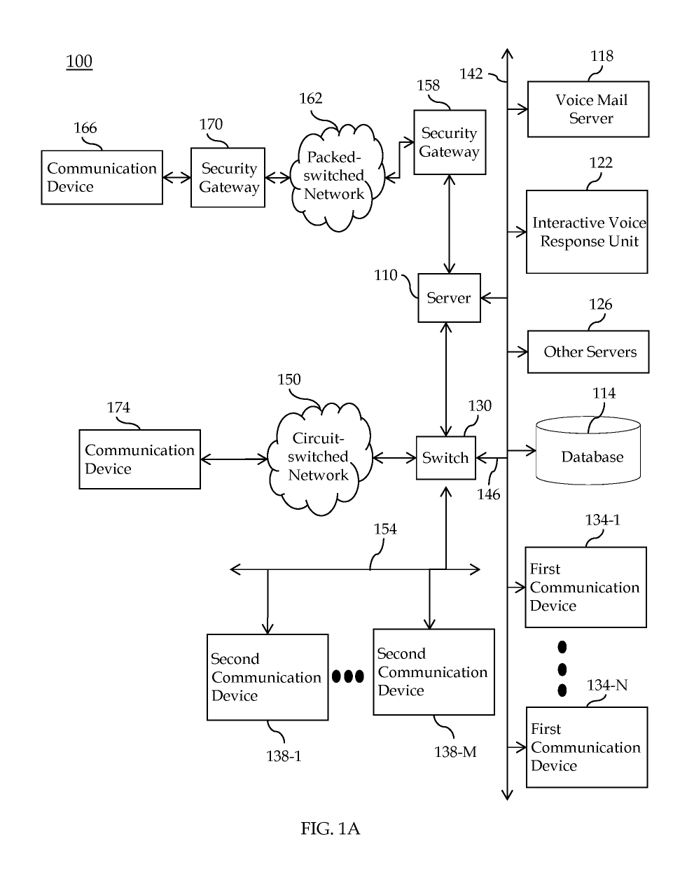

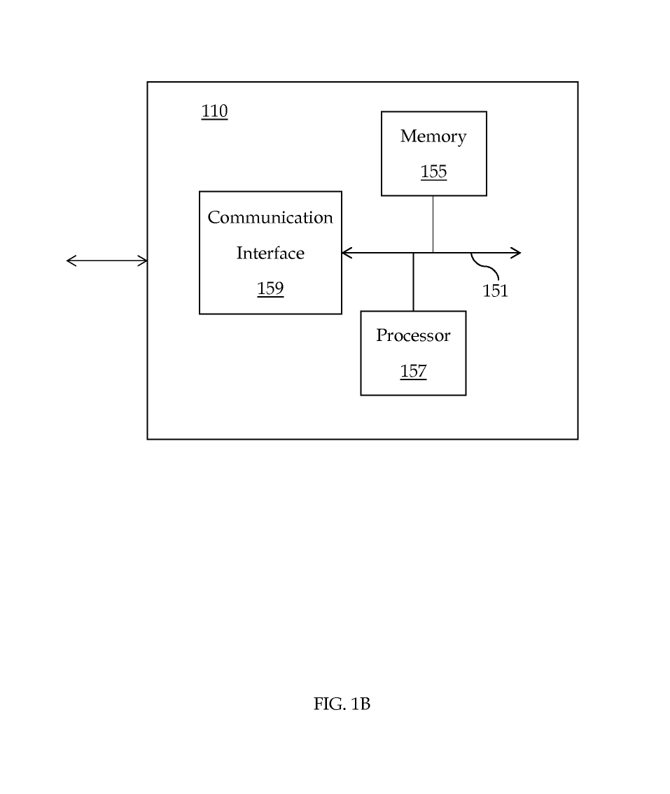

FIG. 1A shows an illustrative embodiment of the present invention. A contact center 100 comprises a server 110, a set of data stores or databases 114 containing contact or customer related information, resource or agent related information and other information that may enhance the value and efficiency of the contact processing, and a plurality of servers, namely a voice mail server 118, an Interactive Voice Response unit (e.g., IVR) 122, and other servers 126, a switch 130, a plurality of working agents operating packet-switched (first) communication devices 134-1-N (such as computer work stations or personal computers), and/or circuit-switched (second) communication devices 138-1-M, all interconnected by a Local Area Network (LAN) 142, (or Wide Area Network (WAN)). In another embodiment of the present invention, the customer and agent related information may be replicated over multiple repositories.

The servers may be connected via optional communication lines 146 to the switch 130. As will be appreciated, the other servers 126 may also include a scanner (which is normally not connected to the switch 130 or Web Server), VoIP software, video call software, voice messaging software, an IP voice server, a fax server, a web server, an email server, and the like. The switch 130 is connected via a plurality of trunks to a circuit-switched network 150 (e.g., Public Switch Telephone Network (PSTN)) and via link(s) 154 to the second communication devices 138-1-M. A security gateway 158 is positioned between the server 110 and a packet-switched network 162 to process communications passing between the server 110 and the packet-switched network 162. In an embodiment of the present invention, the security gateway 158 (as shown in FIG. 1A) may be Avaya Inc.'s, G700 Media Gateway™ and may be implemented as hardware such as via an adjunct processor (as shown) or as a chip in the server 110.

The switch 130 and/or server 110 may be any architecture for directing contacts to one or more communication devices. In some embodiments of the present invention, the switch 130 may perform load-balancing functions by allocating incoming or outgoing contacts among a plurality of logically and/or geographically distinct contact centers. Illustratively, the switch 130 and/or server 110 may be a modified form of the subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company. Typically, the switch 130/server 110 is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide ACD functionality. Other types of known switches and servers are well known in the art and therefore not described in detail herein.

The first communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

The second communication devices 138-1-M are circuit-switched devices. Each of the second communication devices 138-1-M corresponds to one of a set of internal extensions Ext-1-M, respectively. The second communication devices 138-1-M may include, for example, wired and wireless telephones, PDAs, H.320 videophones and conferencing units, voice messaging and response units, traditional computer telephony adjuncts, and any other communication devices.

It should be noted the embodiments of present invention do not require any particular type of information transport medium between switch, or server and first and second communication devices, i.e., the embodiments of the present invention may be implemented with any desired type of transport medium as well as combinations of different types of transport channels.

The packet-switched network 162 may be any data and/or distributed processing network, such as the Internet. The packet-switched network 162 typically includes proxies (not shown), registrars (not shown), and routers (not shown) for managing packet flows.

The packet-switched network 162 as shown in FIG. 1A is in communication with a first communication device 166 via a security gateway 170, and the circuit-switched network 150 with an external second communication device 174.

In one configuration, the server 110, the packet-switched network 162, and the first communication devices 134-1-N are Session Initiation Protocol (SIP) compatible and may include interfaces for various other protocols such as the Lightweight Directory Access Protocol (LDAP), H.248, H.323, Simple Mail Transfer Protocol (SMTP), IMAP4, ISDN, E1/T1, and analog line or trunk.

It should be emphasized the configuration of the switch 130, the server 110, user communication devices, and other elements as shown in FIG. 1A is for purposes of illustration only and should not be construed as limiting embodiments of the present invention to any particular arrangement of elements.

Further, the server 110 is notified via the LAN 142 of an incoming service request or work item by the communications component (e.g., switch 130, a fax server, an email server, a web server, and/or other servers) receiving the incoming service request as shown in FIG. 1A. The incoming service request is held by the receiving telecommunications component until the server 110 forwards instructions to the component to forward or route the contact to a specific contact center resource, such as the IVR unit 122, the voice mail server 118, and/or first or second telecommunication device 134-1-N, 138-1-M associated with a selected agent.

FIG. 1B illustrates at a relatively high-level hardware abstraction of a block diagram of a server such as the server 110, in accordance with an embodiment of the present invention. The server 110 may include an internal communication interface 151 that interconnects a processor 157, a memory 155 and a communication interface circuit 159. The communication interface circuit 159 may include a receiver and transmitter (not shown) to communicate with other elements of the contact center 100 such as the switch 130, the security gateway 158, the LAN 142, and so forth. By use of programming code and data stored in the memory 155, the processor 157 may be programmed to carry out various functions of the server 110.

Although embodiments are discussed with reference to client-server architecture, it is to be understood that the principles of embodiments of the present invention apply to other network architectures. For example, embodiments of the present invention apply to peer-to-peer networks, such as those envisioned by the Session Initiation Protocol (SIP). In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, embodiments of the present invention do not require the presence of packet- or circuit-switched networks.

The term “switch” or “server” as used herein should be understood to include a Private Branch Exchange (PBX), an ACD, an enterprise switch, an enterprise server, or other type of telecommunications system switch or server, as well as other types of processor-based communication control devices such as media servers, computers, adjuncts, etc.

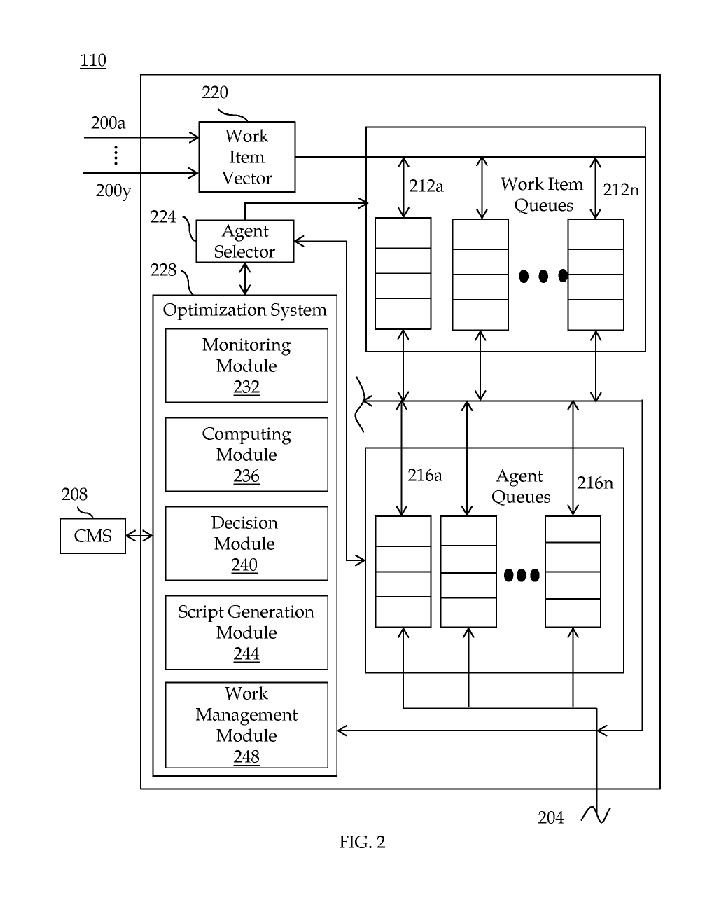

Referring to FIG. 2, one possible configuration of the server 110 is depicted at a relatively high level of functional abstraction, according to an embodiment of the present invention. The server 110 is in communication with a plurality of contact or customer communication lines 200a-y (which may be one or more trunks, phone lines, etc.) and an agent communication line 204 (which may be a voice-and-data transmission line such as the LAN 142 and/or a circuit switched voice line). The server 110 may include Avaya Inc.'s Operational Analyst™ (OA) with On-Line Analytical Processing (OLAP) technology or a Call Management System (CMS) 208 that gathers contact records. OA and CMS will hereinafter be referred to jointly as CMS 208.

As shown in FIG. 2, among the data stored in the server 110 is a set of contact or work item queues 212a-n and a separate set of agent queues 216a-n. Each contact queue 212a-n corresponds to a different set of agent queues, as does each agent queue 216a-n. Conventionally, contacts are prioritized or are either queued in individual ones of the contact queues 212a-n in their order of priority or are queued in different ones of a plurality of contact queues that correspond to a different priority. Likewise, each agent's queues are prioritized according to his or her level of expertise or skill in that queue, and agents are queued in either individual ones of agent queues 216a-n in their order of expertise level or in different ones of a plurality of agent queues 216a-n that correspond to a queue and each one of which corresponds to a different expertise level. In an embodiment of the present invention, the agent queue 216a-n may include a set of reserve agents queue in the contact center 100.

According to an embodiment of the present invention, included among the control programs in the server 110 is a work item vector 220. Contacts or calls incoming to the contact center 100 are assigned by the work item vector 220 to different work item queues 212a-n based upon a number of predetermined criteria, including a customer's identity, customer needs, contact center needs, current contact center queue lengths, a customer value, and an agent skill that is required for proper managing of the contact. Agents who are available for managing work items are assigned to the agent queues 216a-n based upon the skills that they possess. An agent may have multiple skills, and hence may be assigned to multiple agent queues 216a-n simultaneously. Furthermore, an agent may have different levels of skill expertise (e.g., skill levels 1-N in one configuration or merely primary skill levels and secondary skill levels in another configuration), and hence may be assigned to different agent queues 216a-n at different expertise levels.

In one configuration, the contact center 100 is operated by a contract operator (e.g., a supervisor or a manager of the contact center 100), and each of the work item queues 212a-n, and possibly each of the agent queues 216a-n, corresponds to a different client. Each client may have a separate Service Level Agreement (SLA) or other type of performance measurement agreement with the contract operator regarding performance expectations, goals, requirements or specifications for the client's respective queue(s).

Further, embodiments in accordance with the present invention may include, among the programs executing on the server 110, an agent selector 224 and an optimization computer system 228. The agent selector 224 and the optimization computer system 228 are stored either in the main memory or in a peripheral memory (e.g., disk, CD ROM, etc.) or some other computer-readable medium of the contact center 100. Further, the agent selector 224 monitors the occupants of the work item and agent queues 212a-n and 216a-n, respectively, and contact center objectives, rules, and policies and assigns agents to service work items.

The agent selector 224 distributes and connects these work items to communication devices of available agents based on the predetermined criteria noted above. When the agent selector 224 forwards a contact (or first work item) to an agent, the agent selector 224 also forwards customer-related information from the database 114 to the agent's desktop or computer work station for previewing and/or viewing (such as by a pop-up display) to enable the agent for providing better services to the customer. Depending on the contact center configuration, the agent selector 224 may reallocate the work items to the agents of the contact center 100. The agents process the contacts or work items sent to them by the agent selector 224.

In an embodiment of the present invention, the agent and their associated data are maintained and updated in the database 114 of the contact center 100. Upon the completion of managing a work item, a generator (not shown) collects selected metrics for the work item. These metrics may include skills involved in servicing the work item, an identifier of a servicing agent, contact duration, a transaction or contact type (e.g., sale, information request, complaint, etc.), time-of-day, result of the call (e.g., type of sale, number of units sold, an average revenue generated, etc.), and so forth. The metrics along with other statistics is typically gathered by the CMS 208.

According to an embodiment of the present invention, the optimization computer system 228 includes certain modules, such as, but is not restricted to, a monitoring module 232, a computing module 236, a decision module 240, a script generation module 244, and a work management module 248. In some embodiments, one or more of the monitoring module 232, the computing module 236, the decision module 240, the script generation module 244, and the work management module 248 may be implemented by one or more software processes running on the server 110. The server 110 may implement one or more software processes by use of the processor 157 being suitably programmed by use of software instructions stored in the memory 155 coupled to the processor 157.

The monitoring module 232 may monitor a type of incoming work request that is assigned to an agent of the contact center 100, in an embodiment of the present invention. The type of work request may include, but is not limited to, a voice call, a video call, an email, a web chat, an instant messaging, a Voice over Internet Protocol (VoIP), a text message, and so forth. In an embodiment of the present invention, the agent of the contact center 100 may have the capability to simultaneously manage multiple work requests of different media types. In an exemplary embodiment of the present invention, an agent may manage a voice call and two web chats at a same time.

Further, the monitoring module 232 may monitor performance parameters of the agent managing the work requests, in an embodiment of the present invention. The performance parameters of the agent may include, but is not limited to, an agent behavior, load and performance of an agent, sentiments of an agent and/or a customer, and so forth. In an embodiment of the present invention, the behavior of the agent may include a positive agent behavior, or a negative agent behavior. The positive behavior of the agent is indicated when the agent, but is not limited to, manages each of the assigned work requests, completes the work requests, fulfills back end processing requests, completes validation processes, and so forth. The negative behavior of the agent is indicated when the agent, but is not limited to, rejects an incoming work request, prematurely disconnects work requests, not fulfills back end processing requests, bypasses validation processes, and so forth.

In an embodiment of the present invention, the behavior of the agent managing a voice call may be determined by using voice analytics. The behavior of the agent managing a video call may be determined by analyzing, but is not limited to, facial expressions, shaking their heads, nodding, scrunching of eyebrows, and so forth, in another embodiment of the present invention. When the agent is managing a non-voice work request such as a web chat, a text message, etc., then the behavior of the agent and/or the customer may be determined by analyzing their contexts, in yet another embodiment of the present invention.

In another embodiment of the present invention, the monitoring module 232 may further monitor the load and performance parameter of the agent. The load and performance parameter may include, but is not limited to, human error rate, number of work requests assigned to an agent, and so forth, in an embodiment of the present invention. The load and performance parameter of the agent may be monitored by utilizing historical data associated with the agent such as, work request disconnections, customer feedback ratings, an average talk time, a web chat message response time, spell check corrections, emails that fail peer or supervisor approval, etc. For example, an average talk time of an agent is 14 minutes in an hour and it is monitored that the average talk time is decreasing dramatically due to the amount of work managed by the agent of the contact center 100.

The monitoring module 232 may monitor sentiment type of the agent and/or customer during the work requests. The sentiment type may be, but is not restricted to, a positive sentiment and a negative sentiment. The positive sentiments indicate the customer is happy and satisfied from the work request. The negative sentiments indicate the customer is unhappy and unsatisfied from the work request. It may be possible the agent managing the call is not very skilled (or, e.g., a silver-rated agent). Hence, the agent may not be skilled enough to satisfy the customer.

Further, if the customer is already having some complaints, then the agent may face difficulty in managing the work request. The monitoring module 232 may detect the sentiment type of the customer or the agent from start of a work request to an end of the work request, in an embodiment of the present invention. For example, sentiments at the start of a call may be okay but deteriorate as the call proceeds. The monitoring module 232 may also detect the sentiment type in the non-voice work requests, for example, text messages, emails, or instant messaging, etc.

In an embodiment of the present invention, for a voice call, a sentiment detector (not shown) may be plugged into a media server or gateway of the contact center 100 to detect the sentiment type. In another embodiment of the present invention, a text analyzer (not shown) may be used for text related media, e.g., a web chat, a text message, and the forth to detect the sentiment type during the work requests. In yet another embodiment of the present invention, visual gestures of the agent and/or customer are monitored from a media, e.g., a video call, to detect their sentiment type. In an embodiment of the present invention, the performance parameters of the agent of the contact center 100 may be monitored in a real time environment.

The computing module 236 may compute a score for each of the monitored performance parameter, in an embodiment of the present invention. The score may indicate the performance of the agent of the contact center 100 while managing the multiple work requests at a same time, in an embodiment of the present invention. For example, a score “20” is computed for the negative agent behavior, a score “18” is computed for a load and/or human error rate, and a score “67” is computed for the sentiments, based on the monitored performance parameters of the agents. In an exemplary embodiment of the present invention, if a positive behavior of the agent is determined, then a high score, for example, a score more than “50” is computed for the agent, and if a negative behavior is determined then a low score, for example, a score less than “50” is computed for the agent.

In another exemplary embodiment of the present invention, if the agent is managing multiple work requests and is making less errors then a high score, for example, a score more than “45” is computed for the agent, and if the agent is making more errors then a score less than “45” is computed for the agent. In another exemplary embodiment of the present invention, if the agent exhibits positive sentiments then a high score, for example, a score more than “65” is computed for the agent, and if the agent exhibits negative sentiments then a low score, for example, a score less than “65” is computed for the agent.

The computing module 236 may compute a combined score for the monitored performance parameters, in another embodiment of the present invention. For example, a combined score may be computed for all the monitored performance parameters of the agent managing the work requests. In an embodiment of the present invention, a mathematical algorithm may be used to compute the score for the monitored performance parameters.

The computing module 236 may also compute possible combinations of work requests an agent may handle with efficiency at the same time. For example, if an agent is handling two emails and one voice call at the time, then a score is computed for the multiplicity of the agent and if the agent handles two emails and a web chat at the same time, then another score may be computed for the agent.

Further, the computing module 236 may compare the score of each of the performance parameters with a predefined threshold of each of the performance parameters. In an embodiment of the present invention, the predefined threshold may be a normalized value for the performance parameter of the agent of the contact center 100. If the score is below the predefined threshold, then it is determined the agent is managing the multiple work requests in a satisfactory manner. Otherwise, it is determined that necessary actions may be taken. The computing module 236 may compare the combined score of the performance parameters with a predefined threshold of the performance parameters, in another embodiment of the present invention. In an embodiment of the present invention, a mathematical algorithm may be used to compare the score of the monitored performance parameters with the predefined thresholds.

The decision module 240 may determine whether the agent managing multiple work requests is under pressure or not, based on the scores compared with the predefined threshold, in an embodiment of the present invention. Further, the decision module 240 may take necessary actions based on the compared scores of the performance parameters. In an embodiment of the present invention, the decision module 240 may take necessary actions based on inputs received from the computing module 236.

In an embodiment of the present invention, if the computed score is reaching the predefined threshold but is below the predefined threshold then the decision module 240 may determine to generate a script for the agent of the contact center 100. If the computed score is above the predefined threshold then the decision module 240 may determine to manage the work requests assigned to the agent.

The decision module 240 may further determine which possible combination of incoming work requests may be efficiently handled by the agent. For example, an agent may be efficient in handling two emails and a web chat but performance of the agent drops when the agent handles two emails and a voice call. In an embodiment of the present invention, the possible combination of work requests efficiently handled by the agent may be determined based on the computed score.

Further, the decision module 240 may take corrective measures based on the computed score. For example, if the computed score is below the predefined threshold then the decision module 240 may determine there is a need for a training session for the agent so the agent may handle other possible work request combinations with higher efficiencies.

The script generation module 244 may generate a script for the agent managing the work requests based on inputs received from the decision module 240. In an embodiment of the present invention, the script may include, but is not restricted to, a checklist. The checklist may include instructions, but is not restricted to, check grammatical errors in non-voice work requests, perform spell check in non-voice work requests, re-read an email, check whether email is sent to a customer, use goodbye phrases, greet a customer, and so forth. In an embodiment of the present invention, a mathematical algorithm may be used to generate the script for the agent of the contact center 100.

Further, the script generation module 244 may generate and display the script to the agent managing the work requests. In an embodiment of the present invention, the script may be presented to the agent to validate the agent under pressure has carried out all of the required tasks to complete the assigned work requests. In another embodiment of the present invention, the script generation module 244 may generate an alert for the agent indicating their performance has dropped. The script generation module 244 may generate a plurality of alerts comprising a beep, a flash, and a popup.

The work management module 248 may manage the work requests of the agents based on inputs received from the decision module 240. In an embodiment of the present invention, the work management module 248 may increase break time for the agent or may provide a timeout by changing their state. Further, the work management module 248 may allocate some of the work requests of the agent to another agent of the contact center 100.

For example, if the agent is assigned with a voice call and two web chats, then the web chats may be allocated to another agent of the contact center 100 in order to reduce work pressure from the agent. In another embodiment of the present invention, the work management module 248 may automatically allocate some of the work requests from the agent to another agent. The work management module 248 may manually allocate some of the work requests from the agent to another agent, in another embodiment of the present invention.

The work management module 248 may further assign incoming work requests to the agent based on determined multiplicity efficiency of the agent in handling the possible work request combinations. For example, if the agent is efficient in handling two web chats and a voice call, then a possible combination of the work requests, i.e., two web chats and a voice call, may be automatically assigned to the agent. In an embodiment of the present invention, the incoming work requests may be assigned to agents based on statistical data, or historical data associated with the agents.

Further, the work management module 248 may inform a supervisor of the contact center 100 to aid the agent in managing the assigned work requests, in an embodiment of the present invention. In an exemplary embodiment of the present invention, if the agent is assigned with a voice call and two web chats, then the voice call may be transferred to the supervisor of the contact center 100 in order to reduce work pressure from the agent. In an embodiment of the present invention, the assigned work request may be transferred based on the computed score of the multiplicity efficiency of the agent.

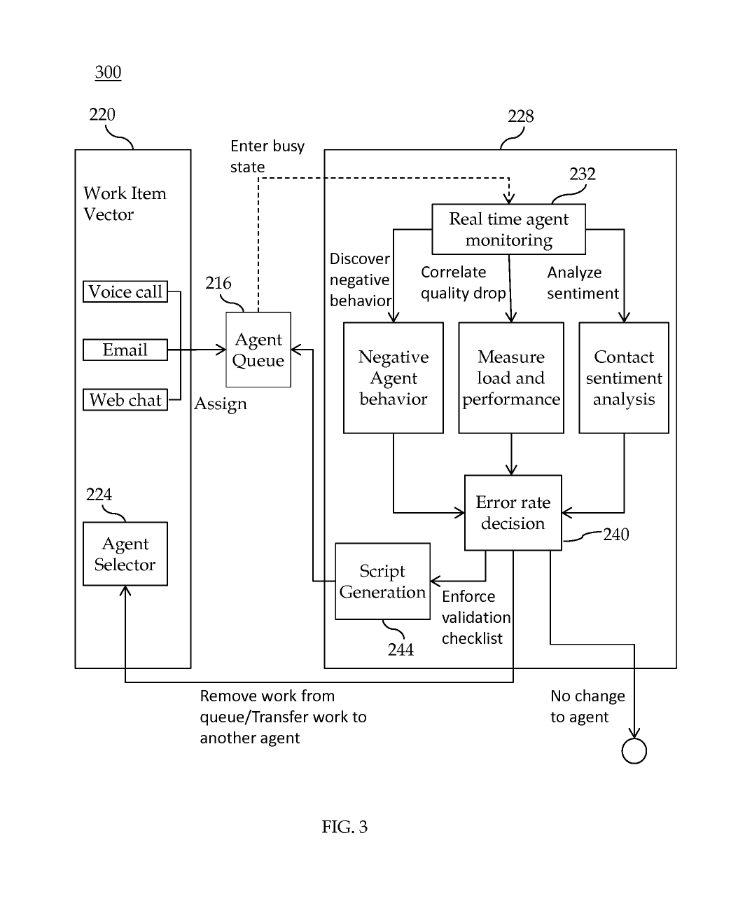

FIG. 3 illustrates an exemplary process flow 300 in which various embodiments may be implemented, according to an embodiment of the present invention. The work item vector 220 receives multiple work requests from customers. The multiple work requests may be of different media type, for example, a voice mail, a video call, an email, a web chat, an instant messaging, a Voice over Internet Protocol (VoIP), a text message, and so forth. The work item vector 220 the assigns the received work requests such as a voice call, an email, and a web chat, to an agent of the agent queue 216 of the contact center 100.

The agent may have the capability to simultaneously manage multiple work requests, in an embodiment of the present invention. When the work is assigned to the agent, then state of the agent is changed from an idle state to a busy state. When it is determined the state of the agent is busy then the real time agent monitoring module 232 monitors performance parameters of the agent while managing the multiple work requests simultaneously. The real time agent monitoring module 232 then monitors a negative agent behavior to determine a negative behavior of the agent. Further, the real time agent monitoring module 232 then monitors and measures load and performance of the agent to determine quality drop while providing services to the customers. For example, the agent managing the multiple work requests may be pressurized while managing the work requests, which may further affect the performance of the agent. The real time agent monitoring module 232 also monitors sentiment type of the agent while providing services to the customers.

Further, the scores of the monitored performance parameters are fed into the error rate decision module 240 to take necessary actions. In an embodiment of the present invention, based on the monitored performance parameters, a score for each of the performance parameter is computed, which is further compared with a predefined threshold of the performance parameters. If it is determined the scores of the performance parameters of the agent are less than the predefined thresholds, then an instruction to enforce validation checklist is provided to the script generation module 244 to generate a script for the agent. The checklist may include instructions, but is not restricted to, check grammatical errors in non-voice work requests, perform spell check in non-voice work requests, re-read an email, check whether email is sent to a customer, use goodbye phrases, greet a customer, and so forth.

Further, the script generation module 244 may display the script to the agent managing the work requests. In an embodiment of the present invention, the script may be presented to the agent to validate the agent under pressure has carried out all of the required tasks to complete the assigned work requests. In another embodiment of the present invention, the script generation module 244 may generate an alert for the agent indicating their performance has dropped. The script generation module 244 may generate a plurality of alerts comprising a beep, a flash, a popup, and the like.

Further, if it is determined the scores of the performance parameters of the agent are less than the predefined threshold, i.e., the agent is managing the work requests without any pressure and performance of the agent is also satisfactory, then there the agent continues managing the work requests. If it is determined the scores of the performance parameters of the agent are more than the predefined threshold, then the work requests assigned to the agent is removed from the queue and is transferred to another resource of the contact center 100 by the agent selector 224. In an embodiment of the present invention, the resource may include, but is not limited to, an agent, a supervisor, a Subject Matter Expert (SME), and the like.

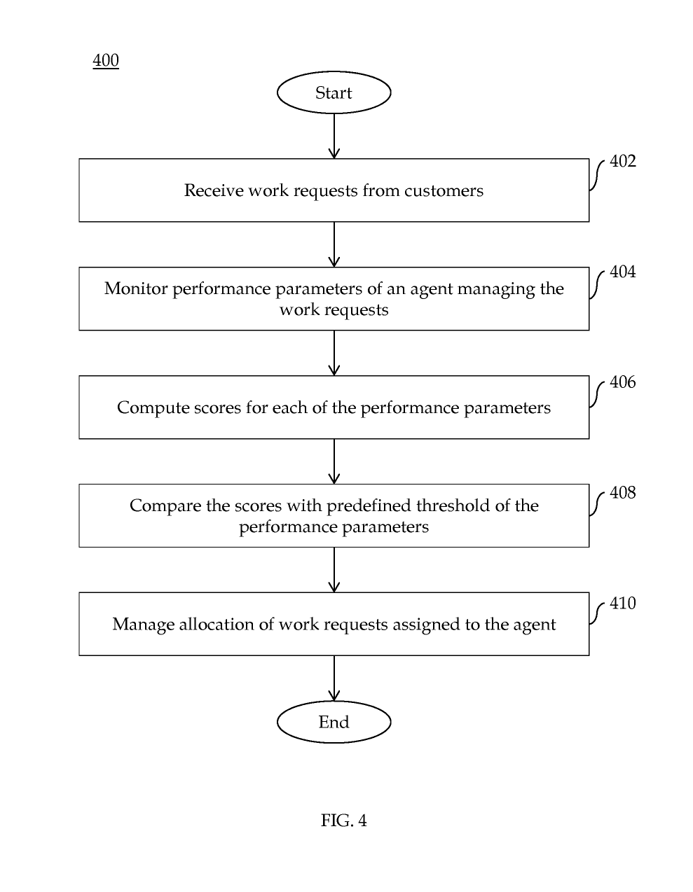

FIG. 4 depicts a flowchart of a method for optimizing performance of an agent in a contact center 100, according to an embodiment of the present invention.

At step 402, an optimization computer system 228 receives work requests from customers. In an embodiment of the present invention, the optimization computer system 228 receives different type of work requests from the customers. The type of work requests may include, but is not restricted to, a voice call, a video call, an email, a web chat, an instant messaging, a Voice over Internet Protocol (VoIP), a text message, and so forth. Further, the received work requests are assigned to an agent of the contact center 100.

At step 404, the optimization computer system 228 monitors performance parameters of the agent managing the work requests. The performance parameters of the agent may include, but is not limited to, an agent behavior, load and performance of an agent, sentiment type of an agent and/or a customer, and so forth. In an embodiment of the present invention, the behavior of the agent may include a positive agent behavior, or a negative agent behavior. The load and performance parameter may include, but is not limited to, human error rate, number of work requests assigned to an agent, and so forth, in an embodiment of the present invention. The sentiment type may be, but is not restricted to, a positive sentiment and a negative sentiment. The positive sentiments indicate that the customer is happy and satisfied from the work request. The negative sentiments indicate that the customer is unhappy and unsatisfied from the work request. In an embodiment of the present invention, the performance parameters of the agent of the contact center 100 may be monitored in a real time environment.

Next, at step 406, the optimization computer system 228 computes a score for each of the monitored performance parameters, in an embodiment of the present invention. The score of the performance parameter may indicate the performance of the agent of the contact center 100 while simultaneously managing the multiple work requests, in an embodiment of the present invention.

In another embodiment of the present invention, the optimization computer system 228 computes a combined score for the monitored performance parameters of the agent. For example, a combined score may be computed for all the monitored performance parameters of the agent who is simultaneously managing the work requests.

At step 408, the optimization computer system 228 compares the score of each of the performance parameters with a predefined threshold of each of the performance parameters. In an embodiment of the present invention, the predefined threshold may be a normalized value for the performance parameter of the agent of the contact center 100. If the score is below the predefined threshold, then it is determined the agent is managing the multiple work requests in a satisfactory manner. Otherwise, it is determined that necessary actions may be taken. The optimization computer system 228 compares the combined score of the performance parameters with a predefined threshold of the performance parameters, in another embodiment of the present invention.

Further, at step 410, the optimization computer system 228 manages allocation of the work requests assigned to the agent. In an embodiment of the present invention, the optimization computer system 228 increases break time for the agent or may provide a timeout by changing their state, for example, changing an agent's state from busy state to an idle state. Further, the optimization computer system 228 allocates some of the work requests of the agent to another agent of the contact center 100. For example, if the agent is assigned with a video call and two emails then the emails are allocated to another agent of the contact center 100 in order to reduce work pressure from the agent. In another embodiment of the present invention, the optimization computer system 228 automatically allocates some of the work requests from the agent to another agent. The optimization computer system 228 manually allocates some of the work requests from the agent to another agent, in another embodiment of the present invention.

Further, the optimization computer system 228 informs a supervisor of the contact center 100 to aid the agent in managing the assigned work requests, in an embodiment of the present invention. In an exemplary embodiment of the present invention, if the agent is assigned with a video call and two web chats, then the video call may be transferred to the supervisor of the contact center 100 in order to reduce work load pressure from the agent.

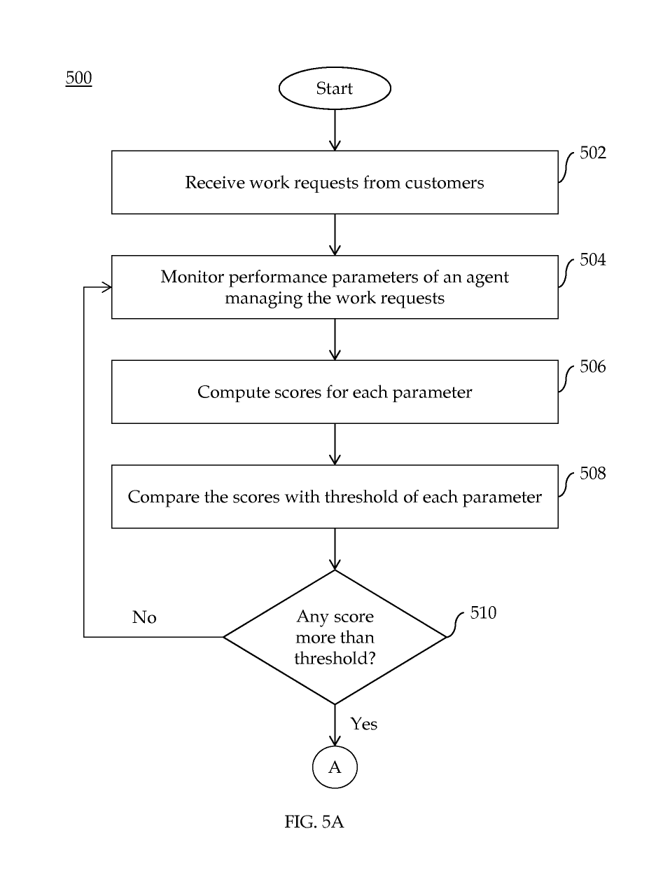

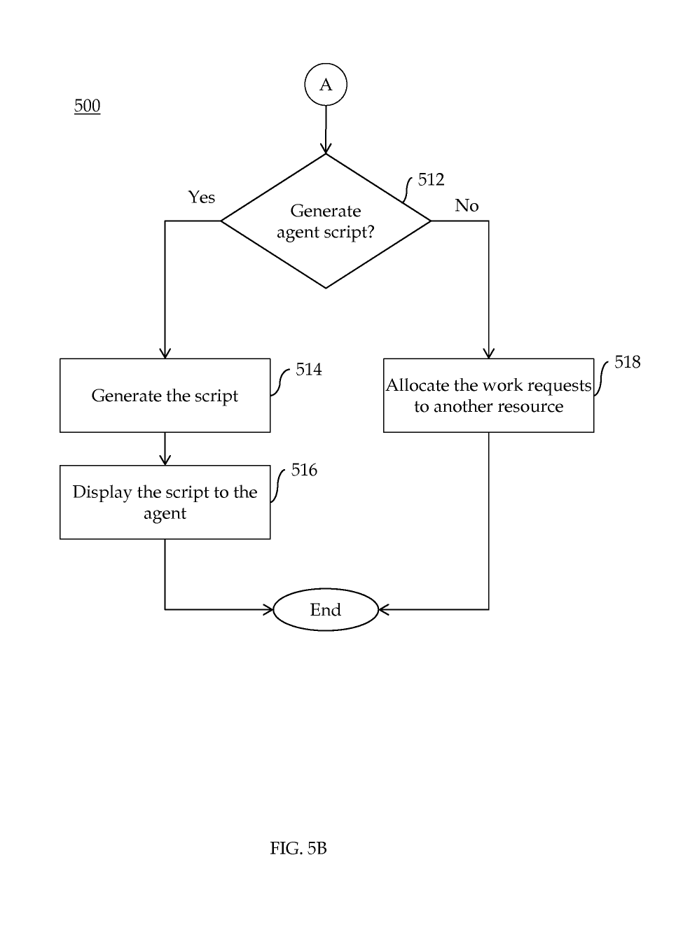

FIGS. 5A and 5B depict a flowchart of a method 500 for optimizing performance of an agent in a contact center 100, according to another embodiment of the present invention.

At step 502, an optimization computer system 228 receives work requests from customers. In an embodiment of the present invention, the optimization computer system 228 may receive different type of work requests from the customers. The type of work requests may include, but is not restricted to, a voice call, a video call, an email, a web chat, an instant messaging, a Voice over Internet Protocol (VoIP), a text message, and so forth. Further, the received work requests are assigned to an agent of the contact center 100.

At step 504, the optimization computer system 228 monitors performance parameters of the agent managing the work requests. The performance parameters of the agent may include, but is not limited to, an agent behavior, load and performance of an agent, sentiment type of an agent and/or a customer, and so forth. In an embodiment of the present invention, the behavior of the agent may include a positive agent behavior, or a negative agent behavior. The load and performance parameter may include, but is not limited to, a human error rate, number of work requests assigned to an agent, and so forth, in an embodiment of the present invention. The sentiment type may be, but is not restricted to, a positive sentiment and a negative sentiment. The positive sentiments indicate that the customer is happy and satisfied from the work request. The negative sentiments indicate that the customer is unhappy and unsatisfied from the work request. In an embodiment of the present invention, the performance parameters of the agent of the contact center 100 are monitored in a real time environment.

Next, at step 506, the optimization computer system 228 computes a score for each of the monitored performance parameters, in an embodiment of the present invention. The score of the performance parameter may indicate the performance of the agent of the contact center 100 while simultaneously managing the multiple work requests, in an embodiment of the present invention.

In another embodiment of the present invention, the optimization computer system 228 computes a combined score for the monitored performance parameters of the agent. For example, a combined score may be computed for all the monitored performance parameters of the agent who is simultaneously managing the work requests.

At step 508, the optimization computer system 228 compares the score of each of the performance parameters with a predefined threshold of each of the performance parameters. In an embodiment of the present invention, the predefined threshold may be a normalized value for the performance parameter of the agent of the contact center 100. If the score is below the predefined threshold, then it is determined the agent is managing the multiple work requests in a satisfactory manner. Otherwise, it is determined that necessary actions may be taken. The optimization computer system 228 compares the combined score of the performance parameters with a predefined threshold of the performance parameters, in another embodiment of the present invention.

Thereafter, at step 510, the optimization computer system 228 determines whether any score is more than the predefined threshold. If it is determined the scores of the performance parameters of the agent are less than the predefined threshold, then the method 500 returns to the step 504 and continues monitoring of the performance parameters of the agent. Otherwise, the method 500 proceeds towards step 512.

At step 512, the optimization computer system 228 determines whether to generate a script for the agent who is simultaneously managing the multiple work requests. If the computed score of the performance parameters of the agent is reaching the predefined threshold but is below the predefined threshold, then the optimization computer system 228 determines to generate a script for the agent and the method 500 proceeds towards step 514. If the computed score is above the predefined threshold of the performance parameters of the agent, then the optimization computer system 228 determines to manage the work requests assigned to the agent and the method 500 proceeds towards step 518.

Further, at step 514, the optimization computer system 228 generates a script for the agent managing multiple work requests. In an embodiment of the present invention, the script may include, but is not restricted to, a checklist. The checklist may include instructions, but is not restricted to, check grammatical errors in non-voice work requests, perform spell check in non-voice work requests, re-read an email, check whether email is sent to a customer, use goodbye phrases, greet a customer, and so forth.

At step 516, the optimization computer system 228 displays the script to the agent managing the work requests. In an embodiment of the present invention, the script may be presented to the agent to validate that the agent under pressure has carried out all of the required tasks to complete the assigned work requests. In another embodiment of the present invention, the optimization computer system 228 generates an alert for the agent indicating that their performance has dropped. The optimization computer system 228 may generate a plurality of alerts comprising a beep, a flash, a popup, and the like.

At step 518, the optimization computer system 228 allocates the work request assigned to the agent to another resource of the contact center 100. The resource may include, but is not limited to, an agent, a supervisor, a Subject Matter Expert (SME), and the like. In an exemplary embodiment of the present invention, an agent is assigned with a video call and two emails then the emails are allocated to another resource of the contact center 100 in order to reduce work pressure from the agent. In another embodiment of the present invention, the optimization computer system 228 automatically allocates some of the work requests from the agent to another resource. The optimization computer system 228 manually allocates some of the work requests from the agent to another resource, in another embodiment of the present invention.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example, in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An optimization computer system for optimizing performance of at least one agent in an enterprise, the optimization computer system comprising:
a monitoring module for monitoring one or more performance parameters of the at least one agent, wherein the at least one agent is managing one or more work requests;
a computing module for computing at least one score for each of the one or more performance parameters, and for comparing the at least one score with one or more predefined thresholds associated with the one or more performance parameters; and
a work management module for managing the one or more work requests assigned to the at least one agent based on comparison of the at least one score with the one or more predefined thresholds.

2. The system of claim 1, wherein the computing module further comprises computing at least one combined score for the one or more monitored performance parameters.

3. The system of claim 1, further comprising a decision module for performing at least one action based on the comparison of the at least one score with the one or more predefined thresholds.

4. The system of claim 1, further comprising a script generation module for generating at least one script for the at least one agent.

5. The system of claim 4, wherein the at least one agent script comprises one or more checklist having instructions to manage the one or more work requests.

6. The system of claim 4, wherein the script generation module is further configured to display the at least one script to the at least one agent.

7. The system of claim 1, wherein the work management module is further configured to allocate one or more resources to manage the one or more work requests.

8. The system of claim 7, wherein the one or more resources is one of an agent, a supervisor, or a Subject Matter Expert (SME).

9. The system of claim 1, wherein the work management module further comprises assigning the one or more work requests to another resource.

10. A computer-implemented method for optimizing performance of at least one agent in an enterprise, the method comprising:
monitoring one or more performance parameters of the at least one agent, wherein the at least one agent is managing one or more work requests;
computing at least one score for each of the one or more performance parameters;
comparing the at least one score with one or more predefined thresholds associated with the one or more performance parameters; and
managing the one or more work requests assigned to the at least one agent based on comparison of the at least one score with the one or more predefined thresholds.

11. The method of claim 10, further comprising computing at least one combined score for the one or more monitored performance parameters.

12. The method of claim 10, further comprising performing at least one action based on the comparison of the at least one score with the one or more predefined thresholds.

13. The method of claim 10, further comprising generating at least one script for the at least one agent.

14. The method of claim 13, wherein the at least one agent script comprises one or more checklist having instructions to manage the one or more work requests.

15. The method of claim 13, further comprising displaying the at least one script to the at least one agent.

16. The method of claim 10, further comprising allocating one or more resources to manage the one or more work requests.

17. The method of claim 16, wherein the one or more resources is one of an agent, a supervisor, or a Subject Matter Expert (SME).

18. A computer-implemented method for optimizing performance of at least one agent in an enterprise, the method comprising:
monitoring one or more performance parameters of the at least one agent, wherein the at least one agent is managing one or more work requests;
computing at least one score for each of the one or more performance parameters;
comparing the at least one score with one or more predefined thresholds associated with the one or more performance parameters; and
allocating at least one resource to manage the one or more work requests.

19. The method of claim 18, further comprising generating at least one script for the at least one agent.

20. The method of claim 19, wherein the at least one agent script comprises one or more checklist having instructions to manage the one or more work requests.
